(19) United States
(12) Patent Application Publication
(10) Pub. No.: US 2007/0092415 A1
(43) Pub. Date: Apr. 26, 2007

(54) Heat-insulated high-temperature reactor

(76) Inventor: Sebastian Muschelknautz, Munchen (DE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 10/556,165

(22) PCT Filed: Apr. 22, 2004
(86) PCT No.: PCT/EP04/04282

§ 371 Date: Dec. 12, 2006

(30) Foreign Application Priority Data
May 9, 2003 (DE) 10320966.2

(51) Int. Cl. B01J 19/00

(52) U.S. Cl. 422/240; 422/129

(57) ABSTRACT

The invention relates to a high-temperature reactor whose high-temperature heat insulation (3) is made from a loosely layered insulating material. A longitudinal expansion gap (5) or a flexible insulating material for compensating for longitudinal expansions of the insulating material is provided at at least one end of the high-temperature reactor.

The invention relates to a high-temperature reactor with heat insulation.

Such high-temperature reactors are used in, e.g., the chemical or petrochemical industry to carry out reactions between different flows of material for producing a product or intermediate product from raw materials. Often, such reactors are intended for oxidation of hydrocarbons, a hydrocarbon-containing fuel, e.g., natural gas, being reacted with an oxygen-containing gas at high-temperatures of, e.g., 1000-1600° C. For example, to produce synthesis gas, cylindrical reactors provided with a steel jacket are used, with cylinders closed with torospherical heads or basket arch bottoms. To protect the steel jacket against heat, a heat-insulating lining of refractory brick and refractory concrete is installed within the reactors. Within the reactor, partial oxidation of gaseous or liquid and solid fuels proceeds at temperatures of, e.g., 1200-1500° C. The flame temperatures can reach 2000° C. and more. Since the existing linings are only designed for temperatures<1600° C., the construction of the lining and of the reactor is made relatively bulging so that there is a great distance between the lining and the flame. The heat insulation consists of refractory brick that is fixed in the wall as a statically self-supporting structure in the reactorjacket with refractory mortar. The refractory mortar promotes soot as a result of its components, such as, e.g., iron oxides.

When the reactor is started, slow heat-up at a heating rate of 30-50°C./h must take place so that stress cracks do not form in the lining and spalling does not take place on the surface. Expansion joints and spacer joints must be adapted to the thermal expansion of the materials. Such reactors are described in, e.g., “Hydrocarbon Technology International, 1994, pp. 125 ff.”

The object of this invention is to configure a device of the initially mentioned type such that the reaction performance level is economically increased, production costs are reduced, and the device starts up promptly.

This object is achieved according to the invention in that the heat insulation is formed from a loosely layered, high-temperature-resistant insulating material. Advantageously, on at least one end side of the high-temperature reactor, there is a linear expansion gap or flexible insulating material for compensation of linear expansion of the insulating material.

In this case, the heat insulation should have heat conduction that is as low as possible in order to reduce heat losses, and it should withstand extremely high temperatures between, e.g., 1500 and 2000° C. In this case, materials with a porous foam and/or fiber structure have been shown to be especially advantageous.,

The invention is based on the finding that the oxygen consumption and reaction performance of reactors depend largely on the reactor temperature, the flame temperature and the heat losses of the reactor. By using loosely layered insulating material of hightemperature-resistant materials for heat insulation, which at the same time have improved insulation action compared to previous materials, the heat losses of the reactor to the outside and in the combustion flame can be significantly reduced.

Conventional high-temperature reactors with conventional reactor design have disadvantages for reactor engineering. The media flowing into the reactor via a burner nozzle produce a pulsed stream that excites a circulation flow in the reactor. This circulation flow causes rapid heat-up of the media to the ignition temperature so that downstream from the burner, a flame forms. Relative to the flame temperature, however, the temperature of the circulation flow is distinctly lower, so that the flame is cooled by the added circulation gas.

These disadvantages can be eliminated by the reactor diameter being reduced and by a pipe flow being produced in the reactor.

With existing linings, there is then the danger of local overheating and subsequent damage to the material. As a result of high thermal conductivity, the insulating layer thickness is larger and thus the reactor jacket diameter is greater, which leads to higher costs.

The heat insulation according to the invention can be advantageously used especially in such pipe flow reactors since it also continuously withstands very high temperatures of more than 1600° C.

Preferably the heat insulation is made of cylindrical or plate-shaped forms, and the forms can be divided over their periphery.

While in the past conventional insulation for high-temperature reactors had to be fixed in the wall of the reactor at the construction site with high time expenditure, the heat insulation of forms according to the invention can be loosely layered and preinstalled.

Conventional insulation, moreover, required soot-promoting refractory mortar that is not necessary for the new material.

The loose layering of the heat insulation enables free thermal expansion so that additional stresses do not occur in the heat insulation.

According to one especially preferred configuration of the invention, there is inner and outer heat insulation, the inner heat insulation having a higher density, hardness and temperature resistance than the outer heat insulation, and the inner heat insulation with forms being loosely layered.

To enable free thermal expansion, the inner heat insulation is preferably separated relative to the outer heat insulation by a gap so that the two heat insulations can move freely against one another. In this case, the outer heat insulation is advantageously securely anchored at least on one end side of the high-temperature reactor.

In order to ensure especially effective heat insulation, the heat-insulating layer is preferably designed with a porous foam and/or fiber structure for low heat conduction of from 0.14 to 0.5 W/mK at temperatures of up to 1600° C.

The heat-insulating layer preferably has long-term resistance at temperatures exceeding 1600° C. The layer suitably consists of high-temperature-resistant materials, especially Al₂O₃ and/or SiO₂ and/or ZrO₂ and/or tungsten. Moreover, the foam and/or fiber structure is preferably soft and flexible, but has a stable shape and a low density from 0.1 to 1 kg/m³, preferably 0.15 to 0.7 kg/M³, especially preferably 0.19 to 0.5 kg/m³. Moreover, the surface of the heat-insulating layer has preferably been subjected to surface treatment.

According to another configuration of the invention, the heat-insulating layer consists of at least two components that are characterized by different density and/or hardness and/or expansion capacity and/or heat conductivity.

To form a directed gas flow while avoiding a circulation flow in the reaction space, especially a pipe flow, the high-temperature reactor is preferably designed such that the reactor wall in an inlet area of the reaction space widens uniformly from the diameter of the inflow opening to the largest diameter of the reaction space. Here, the widening of the wall advantageously comprises an angle of incline of the wall surface to the flow direction of the gas streams in the reaction space of less than 90°, preferably between 0 and 45°, and especially preferably between 30 and 45°. The inlet area, however, can also proceed directly with a sudden widening to a greater pipe diameter, only a small recirculation zone forming at the inlet. As before, large-area circulation is avoided. Furthermore, the flow can discharge directly into a reaction part at the same diameter as the burner. The inlet area is advantageously connected to a cylindrical area of the reaction space with a constant diameter. This cylindrical area is finally followed by an outlet area in which the diameter of the reaction space is preferably reduced in the flow direction.

According to one development of the inventive idea, the cylindrical area and/or the outlet area has a catalyst material. In this way, the reactions of the gas streams can be catalytically influenced in a deliberate manner. Moreover, this enables a further increase of the reaction performance level of the device.

One especially preferred embodiment of the invention is expressed in a deliberate choice of geometrical data of the device, with which the formation of a directed gas flow while avoiding a circulation flow in the reaction space is ensured. Thus, the ratio of the diameter to the length of the reaction space is between 2/3 and 1/30, preferably between 1/2 and 1/20, and especially preferably between 4/10 and 1/10. Moreover, the ratio of the area of the inflow opening cross section to the maximum reaction space cross section is advantageously between 1/2 and 1/20, preferably between 1/4 and 1/10.

A series of advantages is associated with the invention:
Easy, fast set-up and installation.
Preinstallation possible since light materials are used.
Prompt start-up operation since high insulating action and free mobility by thermal expansion of the forms are possible.
No soot-promoting materials.
Smaller insulating wall thickness due to good insulating action.
Better reaction behavior due to higher temperature resistance.
Less soot formation in the flame due to the pipe flow character.

The hightemperature reactor according to the invention is suitable for various purposes:

One application is autothermal ethane cracking. Here, ethane is cracked into an ethylene-containing product gas as oxygen is supplied. To use the device according to the invention in autothermal ethane cracking, the device is designed for the corresponding operating conditions. The reduction of heat losses that is achieved with the invention has a beneficial effect on the economic efficiency of autothermal ethane cracking.

Another possible application is partial oxidation of hydrocarbons into synthesis gas. Here, gaseous and/or liquid and/or solid fuels are treated at temperatures exceeding 1000°C. in the high-temperature reactor. With the high-temperature reactor according to the invention, the reaction performance level can be significantly increased.

One application of interest is also the use of the invention in conjunction with hydrogen technology for propelling motor vehicles. For example, in so-called automobile reformers in a motor vehicle, gasoline can be reformed into hydrogen. One disadvantage of conventional automobile reformers consists in that in the reforming of gasoline, large amounts of soot are formed. With the device according to the invention, a clear reduction of soot formation can be achieved. Moreover, the compact construction is well suited for automobile reformers with a small space requirement.

The invention can also be advantageously used in hydrogen filling stations. For this purpose, the device is structurally designed for the requirements of a hydrogen filling station for production of hydrogen in small reformers. The synthesis gas that is primarily produced can be shifted to a higher hydrogen content with the addition of steam. The remaining carbon monoxide can be reacted into hydrogen and carbon dioxide by a downstream shift reaction. Here, the minimized heat losses and the prompt starting readiness and compact construction of the system are also especially advantageous.

The device can also be designed for a reaction of H₂S and SO₂ in Claus systems. The reduction of heat losses also results in acceleration of the reaction velocity and thus improved reaction performance here.

The invention will be explained in more detail below using figures:

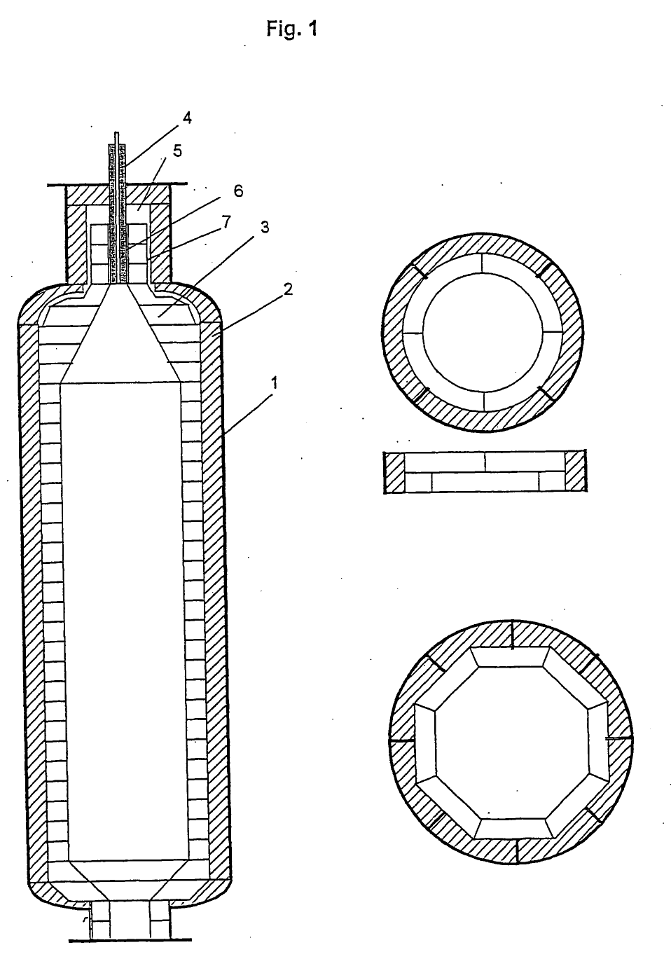

FIG. 1 shows a longitudinal and transverse section of a pipe reactor with heat insulation

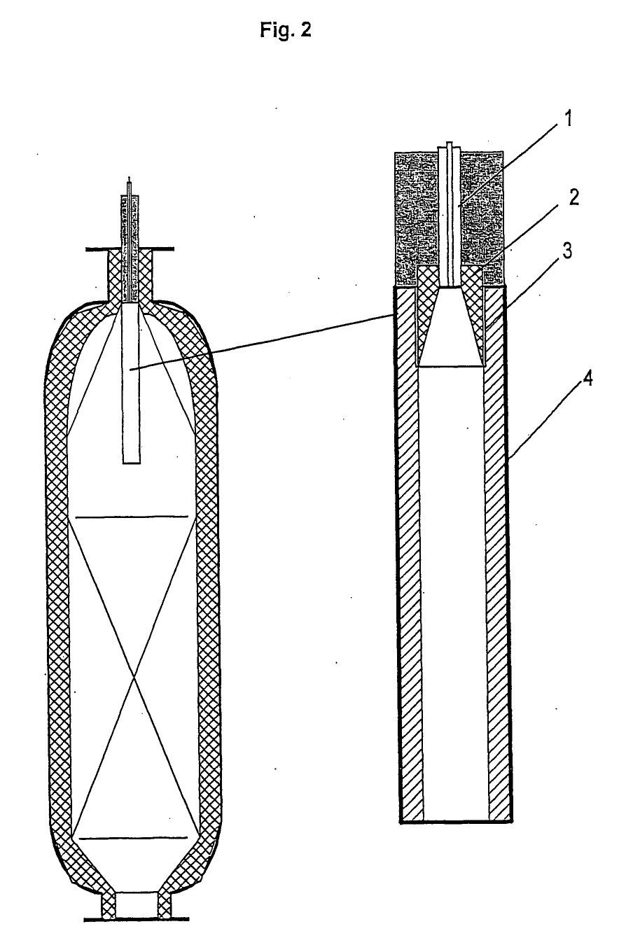

FIG. 2 shows a lengthwise section of a reactor with built-in pipe burner and a detailed view of the pipe burner

The high-temperature reactor shown in FIG. 1 has a reactor jacket 1 with an outer heat insulation 2 and an inner heat insulation 3. The inner insulation has a higher density, hardness and temperature resistance than the outer insulation and is loosely layered with forms. The forms can but need not be divided over their periphery. There is a gap 5 in the upper area for compensation of the linear expansion. The inner insulation 3 is separated relative to the outer insulation 2 by a gap 7 and thus can move freely. The outer insulation in the head area is securely connected to the flanged cover and the cylindrical part of the flange. The burner 4 is separated from the inner insulation by the gap 6 and can move freely. The inner insulation can be made of cylindrical forms or flat plates.

The outer insulation 3 has a lower density and nondeformability than the inner insulation and can accommodate radial expansions of the inner insulation.

As one variant of the pipe reactor, as shown in FIG. 2, a pipe burner can also be used in existing reactors. Here, a combustion chamber pipe with high-temperature insulation 4 is directly connected to the burner 1. The insulation can be placed here in part as a pipe fitting 4. In any case, there must also be axial mobility here, e.g., relative to the diffusor part 2 by a gap 3.

1. High-temperature reactor with heat insulation, characterized in that the heat insulation is formed from loosely layered high-temperature insulating material.

2. High-temperature reactor according to claim 1, wherein the heat insulation is made of cylindrical forms.

3. High-temperature reactor according to claim 1, wherein the heat insulation is made of plate-shaped forms.

4. High-temperature reactor according to claim 2, wherein the forms are divided over their periphery.

5. High-temperature reactor according to claim 1, wherein there is inner and outer heat insulation, the inner heat insulation having a higher density, hardness and temperature resistance than the outer heat insulation and the inner heat insulation with forms being loosely layered.

6. High-temperature reactor according to claim 5, wherein the inner heat insulation is separated relative to the outer heat insulation by a gap, and they can move freely against one another.

7. High-temperature reactor according to claim 5, wherein the outer heat insulation is securely anchored at least on one end side of the high-temperature reactor.

8. High-temperature reactor according to claim 1, wherein the insulating material has a porous foam and/or fiber structure.

9. High-temperature reactor of claim 1, wherein the heat insulation is designed for heat conduction of from 0.14 to 0.5 W/mK at temperatures of up to 1600° C.

10. High-temperature reactor according to claim 1, wherein the heat insulation has long-term resistance at temperatures exceeding 1600° C.

11. High-temperature reactor according to claim 1, wherein the heat insulation consists of high-temperature-resistant materials, especially Al₂O₃ and/or SiO₂ and/or ZrO₂ and/or tungsten.

12. High-temperature reactor according to claim 1, wherein the heat insulation has a low density of from 0.1 to 1 kg/m³, preferably 0.15 to 0.7 kg/m³, especially preferably 0.19 to 0.5 kg/m³.

13. High-temperature reactor according to claim 1, wherein the insulating material is soft and flexible, but has a stable shape.

14. High-temperature reactor according to claim 1, wherein the surface of the insulating material has been subjected to surface treatment.

15. High-temperature reactor according to claim 1, wherein on at least one end side of the high-temperature reactor, there is a linear expansion gap or flexible insulating material for compensation of linear expansion of the insulating material.

16. High-temperature reactor according to claim 1, wherein the insulating parts are connected to one another by formed parts or binders.

17. High-temperature reactor according to claim 1, wherein the high-temperature reactor is made as a reactor for producing synthesis gas by means of partial oxidation of gaseous and/or liquid and/or solid fuels at temperatures exceeding 1000° C.

18. High-temperature reactor according to claim 1, wherein the high-temperature reactor has a geometrical shape that prevents large-area circulation flows and that promotes a directed gas flow in the high-temperature reactor, with a lengthwise extension from the inflow opening to the outflow opening.

19. High-temperature reactor according to claim 1, wherein the ratio of the diameter to the length of the high-temperature reactor is between 2/3 and 1/30, preferably between 1/2 and 1/20, and especially preferably between 4/10 and 1/10.
